(19) United States
(12) Patent Application Publication
(10) Pub. No.: US 2023/0146615 A1
(43) Pub. Date: May 11, 2023

(54) Finger-Operated Cutting Device

(71) Applicant: Edward Scott Carlson, Delmont, PA (US)

(72) Inventor: Edward Scott Carlson, Delmont, PA (US)

(21) Appl. No.: 17/984,226

(22) Filed: Nov. 9, 2022

Related U.S. Application Data
(60) Provisional application No. 63/277,203, filed on Nov. 9, 2021.

(51) Int. Cl. B26B 27/00; A01G 3/02

(52) U.S. Cl. CPC B26B 27/007; A01G 3/02

(57) ABSTRACT

A finger-mounted cutting tool includes an elongated upper cutting blade with a concave curvature and a lower elongated cutting blade with convex curvature, both of which are connected with a pivot pin at one end, plus at least one finger saddle operably engaged with the upper cutting blade, and a thumb pad operably engaged with the lower cutting blade.

### CROSS—REFERENCE TO RELATED APPLICATIONS

This application claims priority to U.S. Provisional Patent Application No. 63/277,203 filed Nov. 9, 2021.

### FIELD OF THE INVENTION

The present invention relates, in general, to small cutting tools, and, more particularly, this invention relates to a finger-mounted snipping and cutting device.

### BACKGROUND OF THE ART

Prior to the conception and development of the present invention, small pruning tools typically required a whole-hand grip with action like making a fist. For any other action with that same hand, the pruning tool must be put down.

Others have attempted to create a small cutting device with mainly finger action. Soucie in U.S. Pat. No. 10,029,376 discloses scissors modified for a thumb ring to aid cutting. Earnst in U.S. Pat. No. 3,374,541 teaches a device for cutting flower stems and the like. Godby in U.S. Patent 519,999, Roberts in U.S. Pat. No. 3,888,006, and Kerns in U.S. Pat. No. 1,775,562 all disclose fruit-picking snips with a ring attachment to the users thumb and use of just one finger opposite the thumb. Alber in US Published Patent Application 2006/0144031 discloses a finger-operated fruit picker cutter with finger and thumb activation.

### BRIEF DESCRIPTION OF THE DRAWINGS

FIG. 1 provides a perspective view of a preferred embodiment of the present invention.

FIG. 2 provides a second perspective view of a preferred embodiment of the present invention.

FIG. 3 is a perspective view of an alternative embodiment of the present invention.

FIG. 4 is a perspective view of an alternative embodiment of the present invention.

FIG. 5 provides an end view detail of a preferred embodiment of the present invention.

FIG. 6 is an side elevation view of an alternative cutting blade design of a preferred embodiment of the present invention.

FIG. 7 is a side elevation view of a detail of the preferred embodiment of the present invention.

FIG. 8 is a perspective view of even yet another alternative embodiment of the present invention.

FIG. 9 is a generally frontal perspective view of the alternative embodiment of the present invention shown in FIG. 10.

FIG. 10 is a generally side perspective view of the alternative embodiment of the present invention shown in FIG. 10.

### BEST MODE FOR CARRYING OUT THE INVENTION

The present invention provides a small cutting implement operated by action of a thumb and one, two, or three fingers. It includes an elongated upper cutting blade with concave curvature and a lower cutting blade with convex curvature, both connected with a pivot pin at one end, additionally having a finger saddle operably engaged with the upper cutting blade; and a thumb pad operably engaged with an opposing cutting blade.

### Detailed Description of a Presently Preferred and Various Alternative Embodiments of the Invention

Prior to proceeding to the more detailed description of the present invention it should be noted that, for the sake of clarity and understanding, very similar components which have identical functions have been identified with identical reference numerals throughout the several views illustrated in the drawing figures.

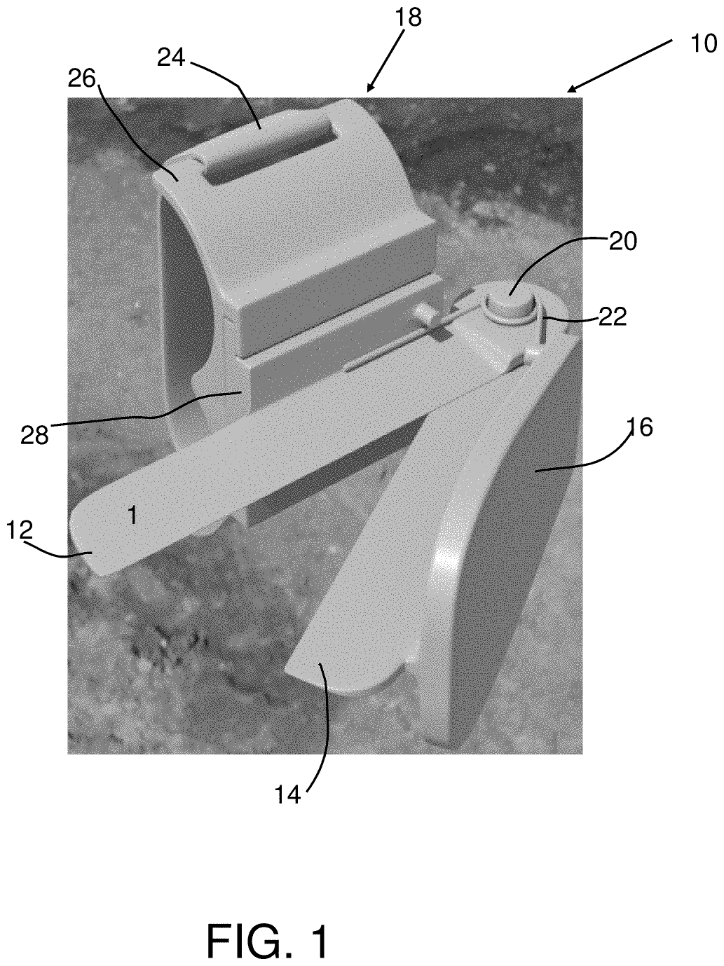

Referring initially to FIG. 1, it provides a perspective view of a preferred embodiment of the present invention generally shown as 10. Two cutting blades 12 and 14 converge at one end on a pivot stud 20. A torsion spring 22 returns the blades to the open position when no pressure is applied. The upper cutting blade 12 is fixed to a base plate 28 of the finger saddle 18. The curved edges 26 of the finger saddle 18 hold the users index and middle finger comfortably in place. A hook and loop strap 24 provides an adjustable means of holding the finger saddle snugly on the fingers. This also allows the cutting implement to be fit over a pair of gloves. For cutting, the user's thumb presses on the thumb pad 16 while the two fingers push down on the saddle 18 to give the two blades the cutting action much like scissors. The location of curved edges 26 and base plate 28 could be reversed.

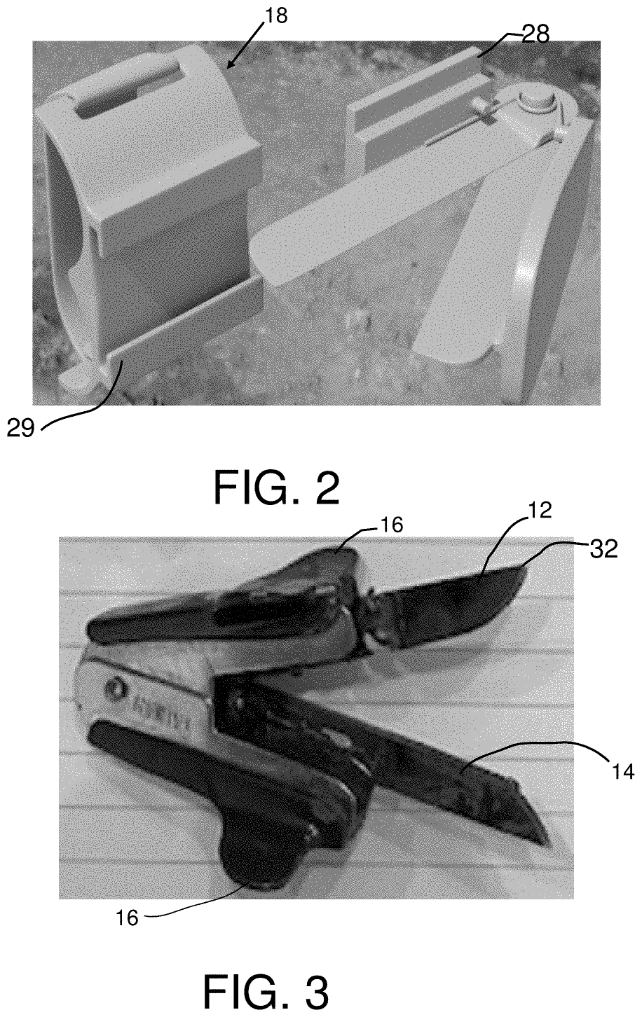

FIG. 2 provides a second perspective view of a preferred embodiment of the present invention illustrating an important feature. The two-finger saddle 18 readily disengages from the base portion 28 via the flange slots 29. The flange slots could instead be on the base portion 28. Since there is also no thumb ring as in the prior art, this disengagement feature makes it simple and quick to remove the cutting blades to free up the thumb and fingers to do something else, and then quickly return to the cutting device. It would also be acceptable for the base portion 28 and the two-finger saddle 18 to be one monolithic part. The thumb pad preferably has a concave non-slip surface.

FIG. 3 is a perspective view of an alternative embodiment of the present invention with no finger saddle on one side. There are the two thumb pads 16, so the tool is reversible and two-finger pressure can still be applied to the side opposite the thumb. The blades 12 and 14 have a curved tip 32 so as to make the jaw wider and easier to guide in the piece to be cut.

FIG. 4 is a perspective view of an alternative embodiment of the present invention. In this embodiment, the upper blade 12 is attached to a flange or similar under two connected finger cots or a two finger portion 36 of a glove or the like as opposed to a rigid finger saddle. The lower blade 14 is operated by a thumb pad 16 such that the two blades 12 and 14 can be pushed into a cutting operation by just the two fingers and a thumb. This contrasts with the fist-making action of most scissors and small pruners.

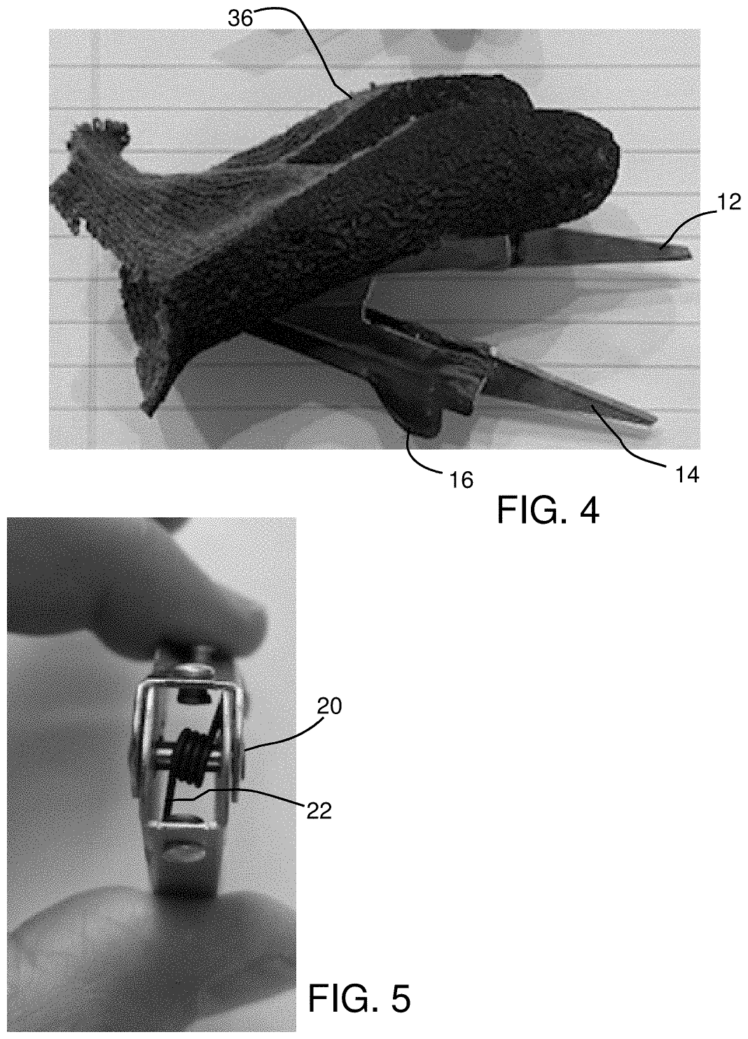

FIG. 5 provides an end view detail of a preferred embodiment of the present invention. The blades are connected at one end to a pivot pin 20. A torsion spring 22 returns the blades to the open position making it more ergonomic for the user in that they only have to actively operate in one direction as opposed to scissors and the like wherein the user must supply the action to both open and close the jaws.

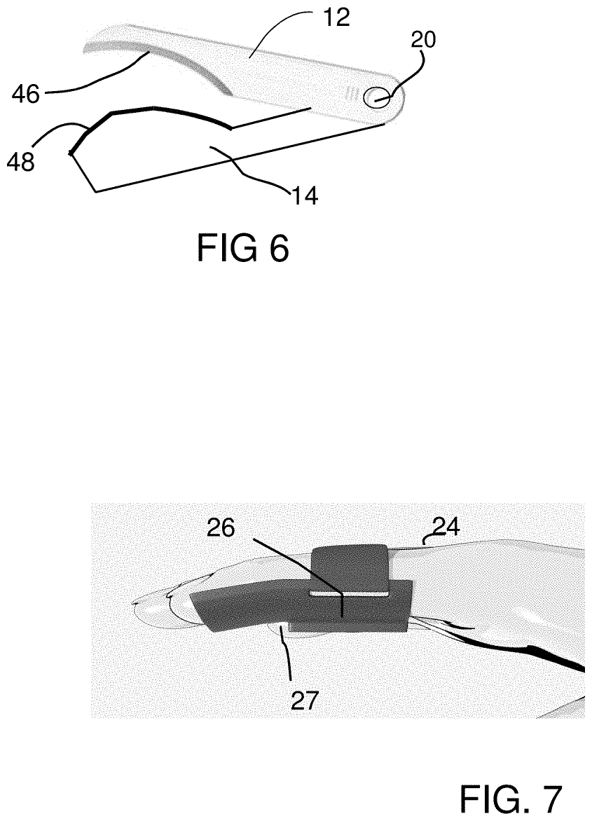

FIG. 6 is a side elevation view of an alternative cutting blade design of a preferred embodiment of the present invention. The upper blade 12 has a concave curved cutting edge 46 and the lower blade 14 has a convex cutting edge 48. The curved portion of the upper blade 12 is configured to mitigate slipping motion of what is being cut.

FIG. 7 is a side elevation view of a detail of the preferred embodiment of the present invention. The finger saddle 26 has a bent portion(s) 27 so it can flex proximal the tip to better match the natural resting position of an index FIG. 24. As above, the saddle is held on the fingers with a hook and loop strip, or other removable attachment means.

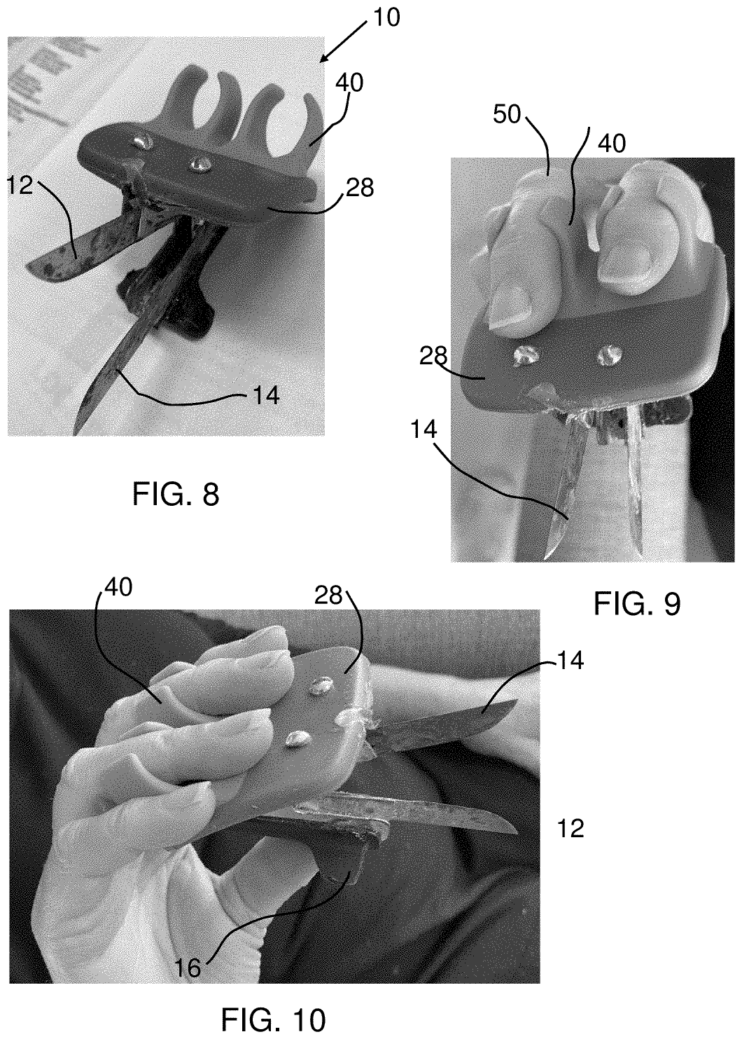

FIG. 8 is a perspective view of even yet another alternative embodiment of the present invention 10. In this variation, the finger saddle consists of two semi-flexible split rings 40 which are attached to the base plate 28 opposite the upper cutting blade 12.

FIG. 9 is a generally frontal perspective view of the alternative embodiment of the present invention shown in FIG. 10. The flexible and split ring nature of the finger saddle allows for easy on-off engagement with fingers 50 of various sizes, both with and without gloves. The at least two split rings 40 are fixed to the base plate 28 such as to enable substantial pressure to be put on the upper cutting blade 12. These two split rings 40 enable the base plate 28 with attached upper cutting blade 12 to be suspended from the two fingers 50.

FIG. 10 is a generally side perspective view of the alternative embodiment of the present invention shown in FIG. 10. Shown in this view is how four fingers can be employed to apply pressure on the base plate 28.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from the spirit of the invention.

### INDUSTRIAL APPLICABILITY

For gardeners and other hobbyists, it is commonplace to frequently use a small scissor-like cutting device intermittently with non cutting activities. There is a long-felt need for a small finger-operating cutting tool that can be readily at hand when a cut is needed.

It is, therefore, one of the primary objects of the present invention to provide a multiple-purpose cutting/pruning tool that, instead of being held, is worn and operated by a thumb and at least two fingers on either hand, even if the fingers are in gloves.

Another object of the present invention is to provide a snipping tool that can remain attached to two fingers when not cutting presently to permit the thumb, palm, and some fingers to engage otherwise.

Still another object of the present invention is to provide a small ergonomic pruning tool that causes less fatigue to the user over an extended period of time.

Yet another object of the present invention is to enable cutting of stems and branches in tight spots.

An additional object of the present invention is to provide a wearable pruning tool with permanent or replaceable blades of various shapes that prevent stems or twigs from sliding out during the cutting motion.

I claim:

1. A finger-mounted cutting tool comprising:
a) an elongated upper cutting blade and a lower elongated cutting blade connected with a pivot pin at one end;
b) at least one finger saddle operably engaged with the upper cutting blade; and
c) a thumb pad operably engaged with the lower cutting blade.

2. The finger-mounted cutting tool of claim 1 wherein said at least one finger saddle are two.

3. The finger-mounted cutting tool of claim 1 wherein said thumb pad has a concave non-slip surface and engages with a thumb only via surface contact.

4. The finger-mounted cutting tool of claim 1 wherein said pivot pin is enclosed within a torsion spring operably engaged with said finger pad and said thumb pad.

5. The finger-mounted cutting tool of claim 2 wherein said finger saddles further include hook-and-loop fasteners.

6. A finger-mounted cutting tool comprising:
a) an elongated upper cutting blade with concave curvature, and a lower elongated cutting blade with convex curvature, both connected with a common pivot pin at one end;
b) at least one finger saddle operably engaged with the upper cutting blade; and
c) a thumb pad operably engaged with the lower cutting blade and configured such that an operating thumb can be readily disengaged for actions other than cutting.

6. The finger-mounted cutting tool of claim 6 wherein said at least one finger saddle are two.

8. The finger-mounted cutting tool of claim 6 wherein said pivot pin is enclosed within a torsion spring operably engaged with said finger pad and said thumb pad.

9. The finger-mounted cutting tool of claim 1 wherein said pivot pin is enclosed within a torsion spring operably engaged with said upper cutting and said thumb pad and configured to separate tips of the two elongated cutting blades at ends opposite the common pivot pin upon.
